(19) United States
(12) Patent Application Publication
(10) Pub. No.: US 2018/0182172 A1
(43) Pub. Date: Jun. 28, 2018

(54) METHOD AND ELECTRONIC DEVICE FOR MANAGING DISPLAY INFORMATION IN FIRST IMMERSIVE MODE AND SECOND IMMERSIVE MODE

(71) Applicant: Brillio LLC, Jersey City, NJ (US)

(72) Inventors: Karthik Gopalakrishnan Vinmani, Bangalore (IN); Renji Kuruvilla Thomas, Bangalore (IN); Jinu Isaac Kuruvilla, Bangalore (IN); Somesh Kanti, Bangalore (IN)

(21) Appl. No.: 15/612,732

(22) Filed: Jun. 2, 2017

(30) Foreign Application Priority Data
Dec. 28, 2016 (IN) 201641044634

(51) Int. Cl. G06T 19/00; G06F 3/01; G06N 99/00; G06K 9/00

(52) U.S. Cl. CPC G06T 19/006; G06K 9/00671; G06N 99/005; G06F 3/011

(57) ABSTRACT

The embodiments herein provide a method for managing display information in a first immersive mode and a second immersive mode of an electronic device. The method includes displaying a plurality of objects in the first immersive mode in a field of view of the electronic device. Further, the method includes determining an object of interest in vicinity to the electronic device, and regulating the display of information of the object of interest in one of the first immersive mode and the second immersive mode based on the current state of the user.

### TECHNICAL FIELD

The embodiments herein generally relate to electronic devices. More particularly relates to a method for managing display information in first immersive mode and second immersive mode of an electronic device. The present application is based on, and claims priority from an Indian Application Number 201641044634 filed on 28 Dec. 2016, the disclosure of which is hereby incorporated by reference herein.

### BACKGROUND

In general, Augmented Reality (AR) technology enhances user experience by blending (i.e., augmenting) virtual components (e.g., digital image, graphics, information, etc.) with real world objects (e.g., image). Contrastingly, the VR technology provides an entire environment generated and driven by a computer system which is immersive in nature. One of the emerging areas in the field of the AR and VR systems is displaying information in various immersive modes in real time by a single specialized device (i.e., displaying information by the electronic device capable of displaying the content both in AR and VR). There exist several mechanisms for switching between AR and VR session but all such mechanisms require an explicit input provided by the user in order to switch between the sessions. Further, the input can be preset/provided at runtime. Further, automatically switching between VR and AR modes remain unexplored to such an extent in which probability of random switching, not intended by the user, is avoided. Thus, hampering the immersive experience of the user.

### SUMMARY

Accordingly, the embodiments herein provide a method for managing display information in a first immersive mode and a second immersive mode of an electronic device. The method includes displaying a plurality of objects in the first immersive mode in a field of view of the electronic device. Further, the method includes determining an object of interest in vicinity to the electronic device, and regulating display of information of the object of interest in one of the first immersive mode and the second immersive mode based on the current state of the user.

In an embodiment, where the first immersive mode is Augmented reality (AR) and the second immersive mode is Virtual reality (VR), regulating the display of information of the object of interest in one of the first immersive mode and the second immersive mode based on the current state of the user includes: determining whether the current state of the user is one of a moving state and a stationary state and causing one of displaying information about the object of interest in the first immersive mode when the current state of the user is detected as the moving state, and switching from the first immersive mode to the second immersive mode when the current state of the user is detected as the stationary state.

In an embodiment, where the first immersive mode is the VR mode and the second immersive mode is the AR mode, regulating the display of the information of the object of interest in one of the first immersive mode and the second immersive mode based on the current state of the user includes: determining whether the current state of the user is one of a moving state and a stationary state; and causing by the immersive manager the electronic device for one of displaying information about the object of interest in the first immersive mode when the current state of the user is detected as the stationary state, and displaying a notification to switch from the first immersive mode to the second immersive mode when the current state of the user is detected as the moving state.

In an embodiment, the object of interest is in vicinity and is one of available in a field-of-view of the electronic device and not available in a field-of-view of the electronic device.

In an embodiment, the plurality of objects, displayed in the field of view of the electronic device, collectively forms a geographic zone which is dynamically identified by a zone recognition manager based on a location of the electronic device.

In an embodiment, determining the object of interest in vicinity to the electronic device includes: determining a probability of a user to transit from a current location to at least one another object in vicinity to the electronic device from an object repository based on a plurality of parameters; and selecting the at least one another object as the object of interest from the object repository based on the probability.

In an embodiment, the plurality of parameters comprises a current activity of the user, a past activity of the user, a future activity of the user, a relation between one object and another object, a distance between one object and another object, and a distance between a current location of the user and another object.

In an embodiment, the objects repository comprises an objects graph formed using a plurality of objects connected among each other based on the plurality of the parameters, wherein the objects graph indicates at least one of a relation between one object to another and a probability of a user to transit from one object to another object.

In an embodiment, the objects graph is dynamically created by a machine learning manager based on a geographic zone identified by a zone recognition manager based on a location of the electronic device.

Accordingly, the embodiments herein provide a method for managing display information in a first immersive mode and a second immersive mode of an electronic device. The method includes displaying a plurality of objects in the first immersive mode and determining an object of interest in vicinity to the user. Further, the method includes detecting whether the object of interest is available in the field-of-view of the electronic device; and regulating display of information of the object of interest in one of the first immersive mode and the second immersive mode based on the availability.

In an embodiment, the method further includes determining, by the immersive manager, an obstacle while viewing at least one object of interest from the plurality of objects in the field of view of the electronic device, wherein the obstacle hides at least one portion of the at least one object of interest. Further, the method includes determining an image corresponding to the at least one object of interest from an object repository based on at least one parameter. Further, the method includes determining the at least one portion of the image corresponding to at least one portion of the obstacle which hides the at least one portion of the object of interest in the field of view of the electronic device, and causing to display the at least one object of interest completely by augmenting the at least one portion of the image on the at least one portion of the obstacle hiding the at least one portion of the at least one object interest.

In an embodiment, where the first immersive mode is the AR and the second immersive mode is the VR, regulating the display of the information of the object of interest in one of the first immersive mode and the second immersive mode based on the availability includes: causing by the immersive manager the electronic device for one of displaying information about the object of interest in the first immersive mode when the object of interest is available in the field-of-view of the electronic device, and switching from the first immersive mode to a second immersive mode when the object of interest is in not available the field-of-view of the electronic device.

In an embodiment, the information about the object of interest is displayed in the first immersive mode when a current state of the user is detected as moving state and the information about the object of interest is displayed in the second immersive mode when a current state of the user is detected as stationary state.

In an embodiment, where the first immersive mode is the VR and the second immersive mode is the AR, regulating the display information of the object of interest in one of the first immersive mode and the second immersive mode based on the availability includes: causing by the immersive manager the electronic device for one of displaying information about the object of interest in the first immersive mode when the object of interest is not available in the field-of-view of the electronic device, and switching from the first immersive mode to a second immersive mode when the object of interest is in available the field-of-view of the electronic device.

In an embodiment, the information about the object of interest is displayed in the first immersive mode when a current state of the user is detected as moving state and the information about the object of interest is displayed in the second immersive mode when a current state of the user is detected as stationary state.

In an embodiment, the plurality of objects, displayed in the field of view of the electronic device, collectively forms a geographic zone which is dynamically identified by a zone recognition manager of the electronic device.

In an embodiment, determining the object of interest in vicinity to the electronic device includes: determining a probability of a user to transit from a current location to at least one another object in vicinity to the electronic device from an object repository based on a plurality of parameters; and selecting the at least one another object as the object of interest from the object repository based on the probability.

In an embodiment, the plurality of parameters comprises a current activity of the user, a past activity of the user, a future activity of the user, a relation between one object to another object, a distance between one object to another object, and a distance between current locations of the user to another object.

In an embodiment, the object repository comprises a machine learning manager configured to manage an objects graph comprising a plurality of objects connected among each other based on the plurality of the parameters, wherein the objects graph indicates at least one of a relation between one abject to another and a probability of a user to transit from one object to another object.

In an embodiment, the objects graph is dynamically created by the machine learning manager based on a geographic zone identified by a zone recognition manager of the electronic device.

Accordingly, the embodiments herein provide an electronic device for managing display information in a first immersive mode and a second immersive mode. The electronic device includes an object repository and a processor coupled to the object repository. The electronic device also includes an immersive manager coupled to the processor which is configured to display a plurality of objects in the first immersive mode in a field of view of the electronic device; determine an object of interest in vicinity to the electronic device; detect a current state of a user of the electronic device; and regulate display of the information of the object of interest in one of the first immersive mode and the second immersive mode based on the current state of the user.

Accordingly, the embodiments herein provide an electronic device for managing display information in a first immersive mode and a second immersive mode. The electronic device includes an object repository and a processor coupled to the object repository. The electronic device also includes an immersive manager coupled to the processor and is configured to: display a plurality of objects in the first immersive mode; determine an object of interest in vicinity to the user; detect whether the object of interest is available in the field-of-view of the electronic device; and regulate the display of information of the object of interest in one of the first immersive mode and the second immersive mode based on the availability.

### BRIEF DESCRIPTION OF THE FIGURES

The embodiments herein will be better understood from the following detailed description with reference to the drawings, in which:

FIG. 1 is a block diagram illustrating various hardware elements of an electronic device for managing display of information in a first immersive mode and a second immersive mode, according to an embodiment as disclosed herein;

FIG. 2 is a state diagram illustrating various states of an electronic device while automatically switching between the first immersive mode and the second immersive mode, according to an embodiment as disclosed herein;

FIG. 3 is a flow diagram illustrating a method for managing display of information in the first immersive mode and the second immersive mode of the electronic device based on a current state of a user, according to an embodiment as disclosed herein;

FIG. 4 is an example scenario illustrating a flow chart for regulating the display of information in first immersive mode, according to an embodiment as disclosed herein;

FIG. 5 is an example scenario illustrating a flow chart for regulating the display of information in second immersive mode, according to an embodiment as disclosed herein;

FIG. 6 is a flow diagram illustrating a method for managing display of information in the first immersive mode and the second immersive mode of the electronic device based on proximity information of a user, according to an embodiment as disclosed herein;

FIG. 7 is an example scenario illustrating a flow chart for regulating the display of information in first immersive mode based on the proximity information of the user, according to an embodiment as disclosed herein;

FIG. 8 is an example scenario illustrating a flow chart for regulating the display of information in second immersive mode based on the proximity information of the user, according to an embodiment as disclosed herein;

FIG. 9 is a flow diagram illustrating various operations performed by the electronic device to determine an object of interest in vicinity to the electronic device, according to an embodiment as disclosed herein;

FIG. 10 is an example representation of an object repository, according to an embodiment as disclosed herein;

FIG. 11 is an example illustration of a user interface (UI) in which immersive view regulating mode is described, according to an embodiment herein;

FIG. 12A illustrates the UI of the electronic device displaying a plurality of objects in AR mode while the user is moving, according to an embodiment as disclosed herein;

FIG. 12B illustrates an example scenario in which the electronic device augments information of the plurality of objects in the AR mode while the user is moving, according to an embodiment as disclosed herein;

FIG. 12C illustrates an example scenario in which the electronic device allows a user to switch to a VR mode on detecting an object of interest which is out of a field of view of the electronic device, according to an embodiment as disclosed herein;

FIG. 12D illustrates an example scenario in which information related to objects of interest which are out of a field of view of an electronic device are presented in VR mode, according to an embodiment as disclosed herein;

FIG. 13 is a flow diagram illustrating various operations performed by the electronic device to augment at least one portion of an image on at least one portion of an obstacle, according to an embodiment as disclosed herein; and

FIGS. 14A-14C illustrates different UIs of the electronic device for augmenting the at least one portion of the image on the at least one portion of the obstacle, according to an embodiment as disclosed herein.

### DETAILED DESCRIPTION OF EMBODIMENTS

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units, managers, or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for managing display information in a first immersive mode and a second immersive mode of an electronic device. The method includes displaying a plurality of objects in the first immersive mode in a field of view of the electronic device. Further, the method includes determining an object of interest in vicinity to the electronic device, and regulating the display information of the object of interest in one of the first immersive mode and the second immersive mode based on the current state of the user.

Unlike to conventional methods and systems, the movement of user is determined and the augmented reality content is altered based on the determined movements of the user.

Generally when a user wears a HMD (Head mounted display) device and walks around a location/street, the user may come across different objects such as shops, companies, people etc., available in that location. Existing mechanisms helps to augment information about the different objects whenever the object is viewed in the field of view of the HMD. Most of the traditional immersive devices such as VR and AR provides restrictive features to view the information about the displayed object. For example, the user can view the basic information of the object using the augment reality technique. However, the detailed information can be viewed by extending the technology to take benefits from the Virtual reality techniques. In case of a combination of VR and AR, the traditional system allows the user to take the benefits of the VR and AR by manually switching between the two modes. Some of the conventional mechanisms are proposed to automate the manual switching process which are limited to predefined conditions or time period which will lead to poor immersive experience for the user.

Unlike the conventional methods and systems, the proposed mechanism allows a user to have an enhanced immersive experience in real time to provide assistance in performing various real time activities such as identification of a specific point in a location, payment of bills, usual activities, etc. When the user wears the HMD device and walks along a particular street or location, the proposed method can be used to dynamically identify the objects of interest available in the street or location in which the user is walking around and provide suggestions to the user about the determined objects of interest. When a user is in a particular location and viewing certain objects such as banks, vegetable shops, coffee shops, companies, branded store etc., then the proposed system can be configured to dynamically identify whether the objects of interest are available in the particular location based on the history of the user, current activity, future activity, etc. For example, if the current user activity is at a “Bank” in a particular location and the future activity, determined by the electronic device, from users email chat application indicates that the user has a meeting with a person at a Coffee shop on the same day, then the proposed invention can be used to identify whether the Coffee shop is available in the particular location of the user. Referring to various embodiments described herein, if it is determined that the Coffee shop is available in the location then a notification indicating the availability of the Coffee shop in the current location is provided to the user. If the Coffee shop is in the line of sight of the user then the user can easily identify it in the particular location based on the notification. In case, the Coffee shop is not available in the line of sight of the user then the proposed invention provides options for the user to switch to VR mode to view/navigate to the Coffee shop in the particular location.

Unlike the conventional methods and systems, the proposed invention provides a seamless switching mechanism from AR to VR or from VR to AR is proposed without compromising on the immersive experience of the user. While the user is walking in the street, it is important to consider the user movements to define a trigger for switching from current immersive mode to other immersive mode. For example, after determining that the Coffee shop is available in the particular location but not in the line of sight of the user in the AR mode, in order to switch to the VR mode to provide assistance to view/navigate to the Coffee shop in the particular location it is important to consider the user movement. When the user is walking around the street while viewing real time stream of real world objects in the AR mode and devices abruptly switches from the AR mode to VR mode, the user cannot view the real time stream of real world objects due to sudden appearance of the objects in VR mode. Further, as the user is still walking and cannot view the real time stream of real world objects, the user have to either remove the worn HMD or have to stop in between the street which will hamper the overall immersive experience of the user. Thus, unlike the conventional methods and systems, the proposed method and system provides seamless switching mechanism by appropriately identifying the current state of the user. If the user is in motion while viewing the real world objects, then the proposed method continues to display the objects in AR mode. When the user becomes stationary, only then the proposed method switches to VR mode to display real world objects.

Unlike the conventional methods and systems, the proposed mechanism allows a social collaboration by dynamically identifying people in a specific location etc. For example, if the user wore the HMD device and walking around the street then the proposed system and method can be used to dynamically access friends list of a user in a social networking application and dynamically identifying availability of one or more friends in the particular location. If one or more friends are available in the particular location then a notification indicating the presence of the one or more friend in the particularly location is provided.

Furthermore, unlike the conventional system and methods, proposed method and system can be used to provide assistance to the user in both indoor environments and the outdoor environments. In an example, when the user in an outdoor environment, such as parks, any street, any lane, company, grounds, shops, monuments, etc. the proposed invention can be used to provide assistance by automatically forming the geographic zone including connected graphs of all the objects in the outdoor environment.

In an example, when the user in an outdoor environment, such as shopping mall, a museum, a multistoried building, etc. the proposed invention can be used to provide assistance by automatically forming the geographic zone including the connected graphs of all the objects within the indoor environment. For e.g., consider a scenario of an indoor environment (i.e., shopping mall) where a user of the electronic device (i.e., HMD device) may start searching for an object of interest (i.e., Formal shirt from “X” brand). According to the conventional methods and systems, the user of the electronic device may therefore start exploring the entire shopping mall or may access external source, associated, within the shopping mall in order to locate the Formal shirt from the “X” brand. Unlike the conventional methods and systems, the proposed method may therefore facilitate the user with the information regarding the object of interest.

Unlike the conventional systems and methods, the present, past and future activities of the user can be accurately tracked to provide assistance to complete a specific activity while the user is enjoying the immersive experience. The proposed system and method can be used to provide added advantage by acting as a personal virtual assistant to help the user to perform the real world task without degrading the immersive experience of the user. For example, the personal virtual assistant to assist the user in shopping, the personal virtual assistant as a guide to explore places to visit in both indoor and outdoor environments, etc.

According to the proposed method, when the user enters the shopping mall with the electronic device (HMD) applied, the electronic device may therefore identify the object of interest (Formal shirt from “X” brand) and thereby provides the location/route at which the user can be able to locate the Formal shirt from “X” brand.

Unlike the conventional methods and systems, the proposed method allows the electronic device to display information of the objects of interest which are in field of view of the electronic device in the AR mode in an outdoor environment.

Consider another example of an outdoor environment scenario (i.e., a street) where a user of the electronic device (i.e., HMD device) may start searching for an object of interest (i.e., book shop). According to the conventional methods and systems, the user of the electronic device may therefore start exploring the entire locality in order to locate the book shop. Unlike to the conventional methods and systems, the proposed method may therefore facilitate the user with the information regarding the object of interest.

According to the proposed method, when the user starts walking in the street with the electronic device (HMD) applied thereto, the electronic device may therefore identify the object of interest (book stores) which are within the field of view and thereby augments information related to the book stores in AR mode.

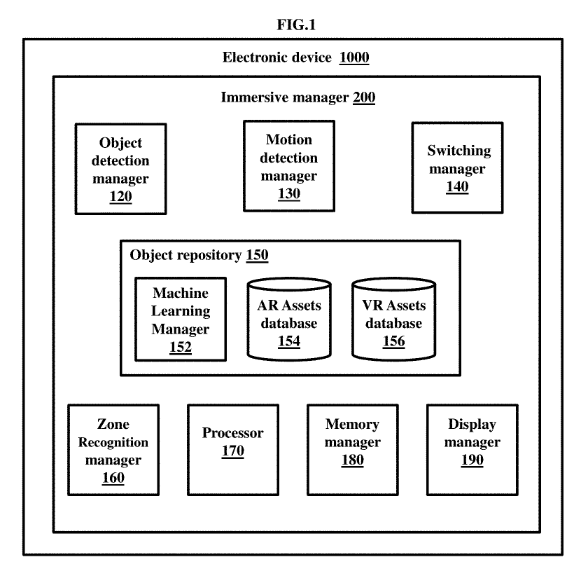

Referring now to the drawings, and more particularly to FIGS. 1 through 14, where similar reference characters denote corresponding features consistently throughout the figures, these are shown as preferred embodiments.

FIG. 1 is a block diagram illustrating various hardware elements of the electronic device 1000 for managing display information in a first immersive mode and a second immersive mode, according to an embodiment as disclosed herein.

In an embodiment, the electronic device 1000 can be, for example, a mobile phone, a smart phone, Personal Digital Assistants (PDAs), a tablet, a wearable device, a Head Mounted display (HMD) device, Virtual reality (VR) devices, Augmented Reality (AR) devices, 3D glasses, display devices, Internet of things (IoT) devices, electronic circuit, chipset, and electrical circuit (i.e., System on Chip (SoC)).

The electronic device 1000 may include an immersive manager 200. The immersive manager 200 can include an object detection manager 120, a motion detection manager 130, a switching manager 140, an object repository 150, a zone recognition manager 160, a processor 170 and a display manager 190.

The term first and second are merely used for labelling purposes, and can be used interchangeably without departing from scope of the invention.

In an embodiment, the object repository 150 includes a machine learning manager 152, an AR assets database 154 and a VR assets database 156.

In an embodiment, the immersive manager 200 can be configured to display a plurality of objects in the first immersive mode in the field of view of the electronic device 1000.

In an embodiment, the object detection manager 120 communicatively coupled to the immersive manager 200 can be configured to detect an object of interest located within the vicinity of the electronic device 1000. The objects of interest may be determined based on an object graph. The object of interest may be located within the line of sight or out of the line of sight of the user. The line of sight of the user is determined based on the field of view of the electronic device 1000 displaying the plurality of objects.

On determining the object of interest, the motion detection manager 130 which is communicatively coupled to the object detection manager 120, is configured to detect the current state of the user. The current state of the user may include, for e.g., moving state of the user, stationary state (not moving) of the user.

Further, the immersive manager 200 can be configured to regulate display of information of the object of interest in one of the first immersive mode and the second immersive mode based on the current state of the user.

In an embodiment, when the motion detection manager 130 detects that the current state of the user is “stationary state”, then the display manager 190 can be configured to display the object of the interest in the first immersive mode (i.e., AR mode view). Similarly, when the motion detection manager 130 detects that the current state of the user of the electronic device 1000 is “moving state”, then the immersive manager 200 can be configured to switch from the first immersive mode (i.e., AR mode) to the second immersive mode (i.e., VR mode).

In an embodiment, the object repository 150 includes an object graph which is formed using a plurality of objects which are connected among each other based on a plurality of parameters. The plurality of parameters includes for e.g., a current activity of the user, a past activity of the user, a future activity of the user, a relation between one object and another object, a distance between one object and another object, and a distance between a current location of the user and another object. The objects graph indicates one of a relation between one object to another and a probability of a user to transit from one object to another object.

In an embodiment, a zone detection manager 160 can be configured to identify a geographic zone based on the current location of the user. The geographic zone can be formed based on the current location of the user. For e.g., if the zone recognition manager 160 identifies the current location of the user is “Location A”, the zone recognition manager 160 may utilize the existing location identification techniques (GPS, maps etc.,) or any other location identification techniques which are yet to be known in the art. Further, based on the current location of the user, i.e., a geo-fence is automatically formed based on the nearby areas to the current location of the user. For example, if the current location of the user is “at company A”, then the zone recognition manager 160 dynamically forms the geo-fence covering a defined geographic zone. Further, the zone recognition manager 160 is configured to identify the different objects such as shops, company, schools, playgrounds, or the like available in the defined geographic zone. Further, the object detection manager 120 is configured to detect whether the object(s) of interest are available in the defined geographic zone based on the current location of the user. For example, if the current location of the user in the defined geographic zone is at company A and the user history indicates that the user usually visits a pizza shop whenever the user visits the company A, then object detection manager 120 is configured to determine whether the pizza shop is actually available in the defined geographic zone. Further, if the pizza shop is available in the defined geographic zone then the object detection manager 120 is configured to indicate the pizza shop as the object of interest of interest to the user.

The memory manager 180 may include one or more computer-readable storage media. Further, the memory manager 180 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory manager 180 may, in some examples, be considered a non-transitory storage medium. The term “non-transitory” may indicate that the storage medium is not embodied in a carrier wave or a propagated signal. However, the term “non-transitory” should not be interpreted that the memory manager 180 is non-movable. In some examples, the memory manager 180 can be configured to store larger amounts of information than the memory. In certain examples, a non-transitory storage medium may store data that can, over time, change (e.g., in Random Access Memory (RAM) or cache). The processor 170 can be configured to interact with the hardware components in the electronic device 1000 to perform various functions.

The display manager 190 can be associated with a display unit capable of being utilized to display on the screen of the electronic device 1000. In an embodiment, the display unit can be, for e.g., a Cathode Ray Tube (CRT), a Liquid Crystal Display (LCD), Organic Light-Emitting Diode (OLED), a Light-emitting diode (LED), Electroluminescent Displays (ELDs), field emission display (FED), etc.,) being interfaced with the immersive manager 200.

The FIG. 1 shows exemplary electronic device 1000 but it is to be understood that other embodiments are not limited thereon. In other embodiments, the electronic device 1000 may include less or more number of hardware elements. Further, the immersive manager 200 may include less or more number of hardware elements.

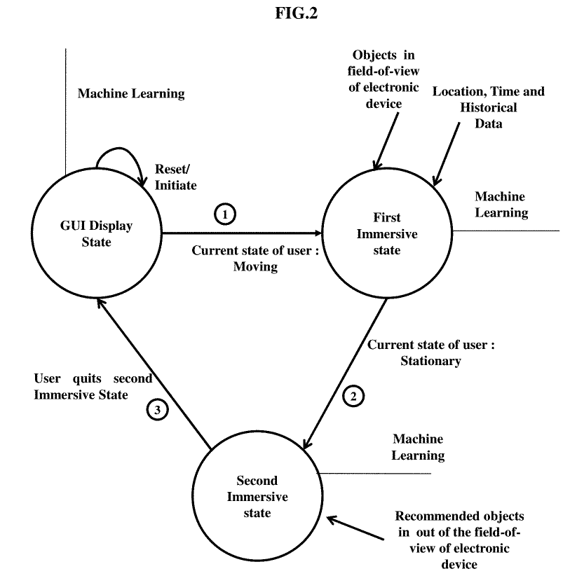

FIG. 2 is a state diagram illustrating various states of the electronic device 1000 while automatically switching between the first immersive mode and the second immersive mode, according to an embodiment as disclosed herein.

Referring to the FIG. 2, there exists three states of the electronic device 1000 [1] Graphical User Interface (GUI) display state, [2] first immersive state, and [3] second immersive state.

Initially, when the user applies the electronic device 1000 (HMD) the electronic device 1000 can be configured to be in the GUI display state. The GUI display state can be managed by the display manager 190. The machine learning manager 152 continuously monitors and records the activities of the user.

When the motion detection manager 130 detects (1) the current state of the user as moving then the immersive manager 200 can be configured to switch the electronic device from the GUI display state to the first immersive mode (AR). When the electronic device 1000 is in the first immersive mode, the state of the electronic device 1000 can be defined as the first immersive state. In the first immersive state, the immersive manager 200 can be configured to display the objects of interest which are located within the field of view (in line of sight) of the electronic device 1000 in the first immersive mode (for e.g., augments the information of the object's in the AR mode). Further, the machine learning manager 152 can be configured to dynamically update the plurality of parameters during the first immersive state of the electronic device 1000.

Further, when the motion detection manager 130 detects (2) that the current state of the user is stationary then the immersive manager 200 can be configured to switch the electronic device 1000 from the first immersive state to the second immersive mode (VR). When the electronic device 1000 is in the second immersive mode, the state of the electronic device 1000 can be defined as the second immersive state. In the second immersive state, the immersive manager 200 can be configured to display the objects of interest which are not in the field (not in line of sight) of view of the electronic device 1000 in the second immersive mode (for e.g., VR mode). Further, the machine learning manager 152 can be configured to dynamically update the plurality of parameters during the second immersive state of the electronic device 1000.

Once the immersive manager 200 detects (3) an input, from the user/default timer set, to exit the immersive session in the second immersive state, then the immersive manager 200 can be configured to switch to the GUI display state.

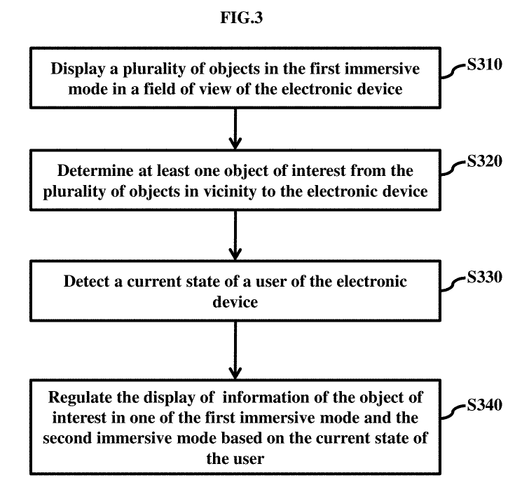

FIG. 3 is a flow diagram illustrating a method for managing display of information in the first immersive mode and the second immersive mode of the electronic device 1000 based on the current state of the user, according to an embodiment as disclosed herein.

Referring to the FIG. 3, at S310, the electronic device 1000 displays the plurality of objects which are located within the field of view of the electronic device 1000 in the first immersive mode. For example, in the electronic device 1000 as illustrated in the FIG. 1, the immersive manager 200 can be configured to displays the plurality of objects which are located within the field of view of the electronic device 1000 in the first immersive mode.

At S320, the electronic device 1000 determines at least one object of interest from the plurality of objects in vicinity to the electronic device 1000. For example, in the electronic device 1000 as illustrated in the FIG. 1, the object detection manager 120 can be configured to determine at least one object of interest from the plurality of objects in vicinity to the electronic device 1000.

At S330, the electronic device 1000 detects the current state of the user of the electronic device 1000. For example, in the electronic device 1000 as illustrated in the FIG. 1, the motion detection manager 140 can be configured to detect the current state of the user of the electronic device 1000.

At S340, the electronic device 1000 regulates the display of information of the object of interest in one of the first immersive mode and the second immersive mode based on the current state of the user. For example, in the electronic device 1000 as illustrated in the FIG. 1, the switching manager 150 can be configured to regulate the display of information of the object of interest in one of the first immersive mode and the second immersive mode based on the current state of the user.

In an example, consider a scenario where the user of the electronic device 1000 is walking in a street and looking for vegetarian restaurant X. The electronic device 1000 displays the objects which are located within its field of view. The electronic device 1000 determines the object of interest as vegetarian restaurant X. Further, the electronic device 1000 determines all other vegetarian restaurants that may be potential objects of interest for the user which are located within the vicinity of the user. The electronic device 1000 determines whether the current state of the user as moving or stationary. On determining that the current state of the user is moving, the electronic device 1000 augments the details of the vegetarian restaurants located within its field of view in the AR mode. On determining that the current state of the user is stationary, the electronic device 1000 displays the details of the vegetarian restaurants not in its field of view (i.e., an adjacent street or area) in VR mode.

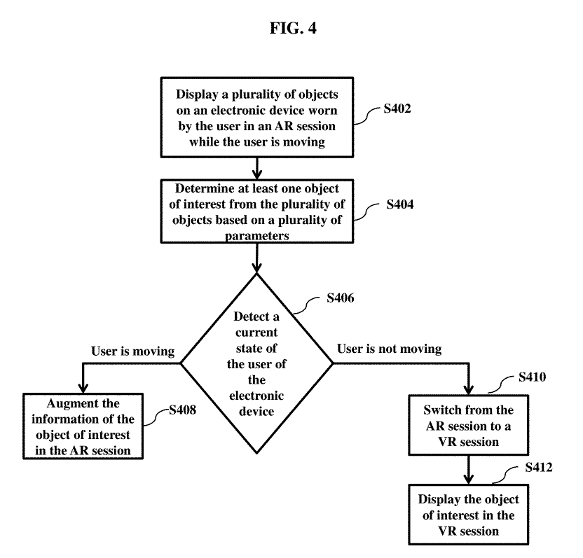

FIG. 4 is an example scenario illustrating a flow chart for regulating the display of information in the first immersive mode, according to an embodiment as disclosed herein

Referring to the FIG. 4, at S402, the electronic device 1000 displays the plurality of objects on the electronic device 1000 worn by the user in the AR session while the user is moving. For example, in the electronic device 1000 as illustrated in the FIG. 1, the immersive manager 200 can be configured to display the plurality of objects on the electronic device 1000 worn by the user in the AR session while the user is moving.

At S404, the electronic device 1000 determines at least one object of interest from the plurality of objects based on the plurality of parameters. For example, in the electronic device 1000 as illustrated in the FIG. 1, the object detection manager 120 can be configured to determine at least one object of interest from the plurality of objects based on the plurality of parameters.

At S406, the electronic device 1000 detects the current state of the user. On determining that the user is moving, at S408 the electronic device 1000 augments the information of the object of interest in the AR session. On determining that the user is stationary, at S410 the electronic device 1000 switches from the AR session to the VR session.

At S412, the electronic device 1000 displays the object of interest in the VR session. For example, in the electronic device 1000 as illustrated in the FIG. 1, the display manager 190 is configured to display the object of interest in the VR session.

In an example, consider that the user is walking in a street with the HMD on and browses for an electrical store. Based on the current activity of the user, the HMD displays all the electrical stores that are located on the street in the AR mode. The HMD determines that the object of interest of the user is electrical stores. Further, the HMD detects the currents state of the user. On determining that the current state of the user is moving, the HMD displays the electrical stores which are located within its field of view with information related to the electric stores augmented in the AR mode.

On determining that the current state of the user is stationary, the HMD displays the electrical stores which are located in an adjacent street but are out of the field of view of the electronic device 1000 in a second immersive mode i.e., VR mode.

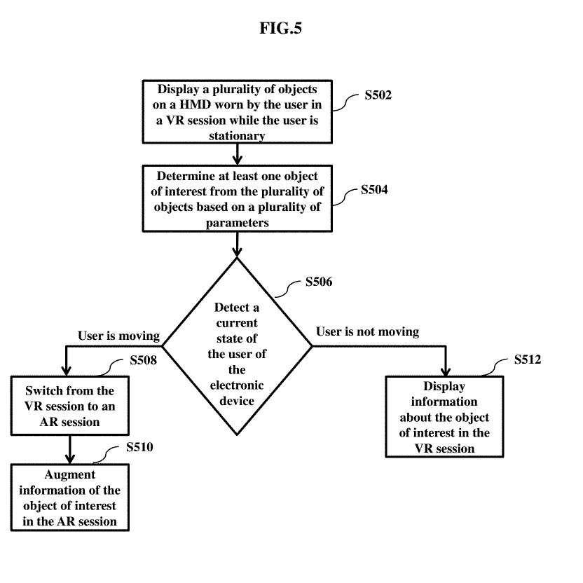

FIG. 5 is an example scenario illustrating a flow chart for regulating the display of information in the second immersive mode, according to an embodiment as disclosed herein

Referring to the FIG. 5, at S502, the electronic device 1000 displays the plurality of objects on the electronic device 1000 worn by the user in the VR session while the user is stationary. For example, in the electronic device 1000 as illustrated in the FIG. 1, the immersive manager 200 can be configured to display the plurality of objects on the electronic device 1000 worn by the user in the VR session while the user is stationary.

At S504, the electronic device 1000 determines at least one object of interest from the plurality of objects based on the plurality of parameters. For example, in the electronic device 1000 as illustrated in the FIG. 1, the object detection manager 120 can be configured to determine at least one object of interest from the plurality of objects based on the plurality of parameters.

At S506, the electronic device 1000 detects the current state of the user. On determining that the user is moving, at S508 the electronic device 1000 switches from the VR session to the AR session.

At S510, the electronic device 1000 augments the information of the object of interest in the AR session. For example, in the electronic device 1000 as illustrated in the FIG. 1, the display manager 190 is configured to augment the information of the object of interest in the AR session.

On determining that the user is stationary, at S512 the electronic device 1000 displays the information about the object of interest in the VR session.

In an example, consider that the user is standing in a mall with the HMD device worn. The HMD device based on the user history determines that the user is interested in buying cosmetics. The HMD device determines the cosmetic stores located in the mall have discounts going on and displays the details in VR mode when the user is stationary.

When the user starts to move, the HMD device switches to the AR mode and augments the information related to the cosmetic stores which are located within the field of view of the HMD in the AR mode.

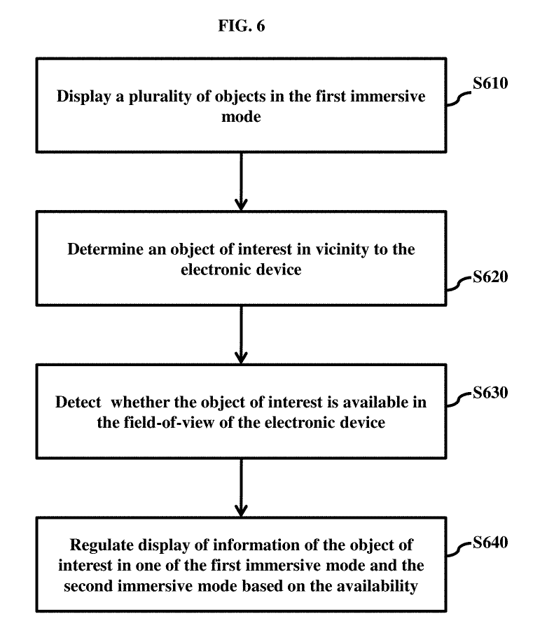

FIG. 6 is a flow diagram illustrating a method for managing display of information in a first immersive mode and a second immersive mode of an electronic device 1000 based on proximity information of a user, according to an embodiment as disclosed herein;

Referring to the FIG. 6, at S610, the electronic device 1000 displays the plurality of objects in the first immersive mode in the field of view of the electronic device 1000. For example, in the electronic device 1000 as illustrated in the FIG. 1, the immersive manager 200 can be configured to display the plurality of objects in the first immersive mode in the field of view of the electronic device 1000.

At S620, the electronic device 1000 determines at least one object of interest from the plurality of objects in vicinity to the electronic device 1000. For example, in the electronic device 1000 as illustrated in the FIG. 1, the object detection manager 120 can be configured to determine at least one object of interest from the plurality of objects in vicinity to the electronic device 1000.

At S630, the electronic device 1000 detects whether the object of interest is available in the field-of-view of the electronic device 1000. For example, in the electronic device 1000 as illustrated in the FIG. 1, the immersive manager 200 can be configured to detect whether the object of interest is available in the field-of-view of the electronic device 1000.

At S640, the electronic device 1000 regulates the display of information of the object of interest in one of the first immersive mode and the second immersive mode based on the availability. For example, in the electronic device 1000 as illustrated in the FIG. 1, the switching manager 150 can be configured to regulate the display of information of the object of interest in one of the first immersive mode and the second immersive mode based on the availability.

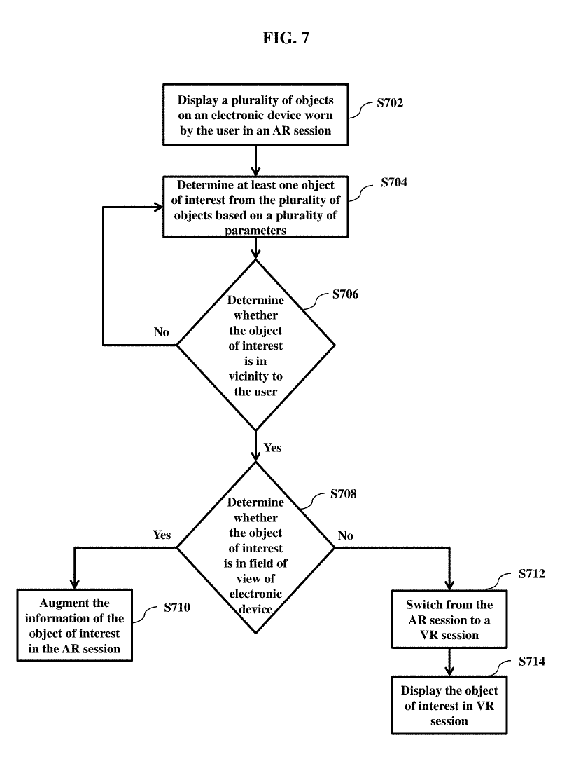

FIG. 7 is an example scenario illustrating a flow chart for regulating the display of information in first immersive mode based on the proximity information of the user, according to an embodiment as disclosed herein;

Referring to the FIG. 7, at S702, the electronic device 1000 displays the plurality of objects on the electronic device 1000 worn by the user in the AR session. For example, in the electronic device 1000 as illustrated in the FIG. 1, the immersive manager 200 can be configured to display the plurality of objects on the electronic device 1000 worn by the user in the AR session.

At S704, the electronic device 1000 determines at least one object of interest from the plurality of objects based on the plurality of parameters. For example, in the electronic device 1000 as illustrated in the FIG. 1, the object detection manager 120 can be configured to determine at least one object of interest from the plurality of objects based on the plurality of parameters.

At S706, the electronic device 1000 determines whether the object of interest is in vicinity to the user. On determining that the object of interest is not in vicinity to the user, the electronic device 1000 loops to S704.

On determining that the object of interest is in vicinity to the user, the electronic device 1000 at S708 determines whether the object of interest is in field of view of electronic device 1000. On determining that the object of interest is in field of view of electronic device 1000, at S710 the electronic device 1000 augments the information of the object of interest in the AR session. On determining that the object of interest is not in field of view of electronic device 1000, at S712 the electronic device 1000 switches from the AR session to the VR session.

At S714, the electronic device 1000 displays the object of interest in the VR session. For example, in the electronic device 1000 as illustrated in the FIG. 1, the display manager 190 is configured to display the object of interest in the VR session.

In an example, consider that the user is walking within a university campus which is not a well-known location. The electronic device 1000 (e.g., HMD) forms a geographic zone of various potential objects based on the current location of the user (using existing mechanisms like the GPS). Further, the HMD displays details of various departments (for e.g., name of the HOD, faculty details, course details, and research publications etc.,) which are located within the field of view of the HMD. The HMD determines that the object of interest of the user is the library block. It checks if the library block is located within the vicinity to the user. Further, the HMD also determines if the library block is located within the field of view of the HMD. If the HMD determines that the library block is within the field of view then it displays the information of the library block in the AR mode. If the HMD determines that the library block is located out of the field of view then the HMD switches to VR mode and displays the information of the library block.

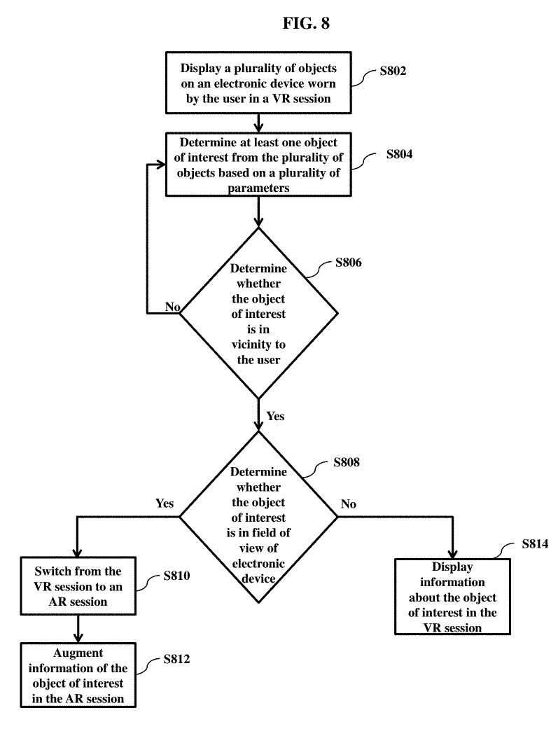

FIG. 8 is an example scenario illustrating a flow chart for regulating the display of information in second immersive mode based on the proximity information of the user, according to an embodiment as disclosed herein;

Referring to the FIG. 8, at S802, the electronic device 1000 displays the plurality of objects on the electronic device 1000 worn by the user in the VR session. For example, in the electronic device 1000 as illustrated in the FIG. 1, the immersive manager 200 can be configured to display the plurality of objects on the electronic device worn by the user in the VR session.

At S804, the electronic device 1000 determines at least one object of interest from the plurality of objects based on the plurality of parameters. For example, in the electronic device 1000 as illustrated in the FIG. 1, the object detection manager 120 can be configured to determine at least one object of interest from the plurality of objects based on the plurality of parameters.

At S806, the electronic device 1000 determines whether the object of interest is in vicinity to the user. On determining that the object of interest is not in vicinity to the user, the electronic device 1000 loops to S804.

On determining that the object of interest is in vicinity to the user, the electronic device 1000 at S808 determines whether the object of interest is in field of view of electronic device 1000.

On determining that the object of interest is in field of view of electronic device 1000, at S810 the electronic device 1000 switches from the VR session to the AR session. At S812, the electronic device 1000 displays the object of interest in the AR session. For example, in the electronic device 1000 as illustrated in the FIG. 1, the display manager 190 is configured to display the object of interest in the AR session.

On determining that the object of interest is not in field of view of electronic device 1000, at S814 the electronic device 1000 displays the information about the object of interest in the VR session.

In an example, consider that the user is stationary and wearing the HMD. The user is viewing the details of a coffee shop details such e.g., the traffic within, seating availability, menu etc., in VR mode. The HMD determines that the object of interest of the user is coffee shop and checks for coffee shops which are located within the vicinity to the user. The HMD forms a geographic zone of various objects of interest based on the location of the user. Further, the HMD determines if the coffee shops are located within the field of view of the HMD. If the HMD determines that the coffee shops are located out of the field of view i.e., in an adjacent street, the HMD continues to display the information of the coffee shops in the VR mode. If the HMD determines that the coffee shops are located within the field of view i.e., in the same street where the user is standing, the HMD switches to AR mode and displays the information of the coffee shops.

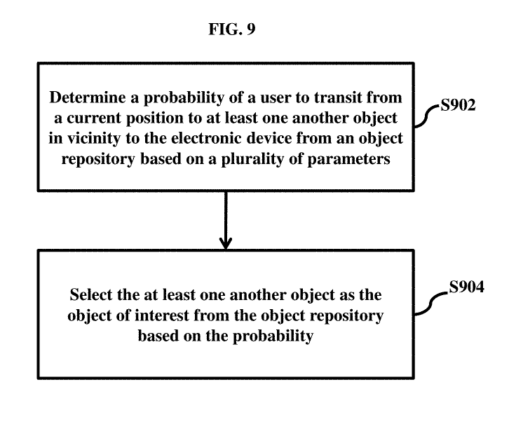

FIG. 9 is a flow diagram illustrating various operations performed to determine the object of interest in vicinity to the electronic device 1000, according to an embodiment as disclosed herein.

Referring to the FIG. 9, at S902, the electronic device 1000 determines the probability of the user to transit from the current position to at least one another object in vicinity to the electronic device 1000 based on the plurality of parameters. For example, in the electronic device 1000 as illustrated in the FIG. 1, the machine learning manager 152 within the object repository 150 can be configured to determine the probability of the user to transit from the current position to at least one another object in vicinity to the electronic device 1000 based on the plurality of parameters. In another embodiment, the machine learning manager 152 can be associated with object repository 150.

At S904, the electronic device 1000 selects the at least one another object as the object of interest from the object repository based on the probability. For example, in the electronic device 1000 as illustrated in the FIG. 1, the machine learning manager 152 within the object repository 150 can be configured to select the at least one another object as the object of interest from the object repository based on the probability.

In an example, consider that the current position of the user is ‘bank X’. The electronic device 1000 based on the user history determines the probability of the user to visit another location for e.g., a water board nearby. Based on the probability determined, the electronic device 1000 selects the water board as the other object of interest of the user and provides information related to it on the electronic device 1000.

In another example, consider that the user is at a tourist destination say Mysore Palace. The electronic device 1000 based on the current location determines the probability of the user to see the golden throne which is located within the Mysore palace. Based on the probability determined, the electronic device 1000 presents information regarding the golden throne like its location within the palace premises, historic data etc., to the user.

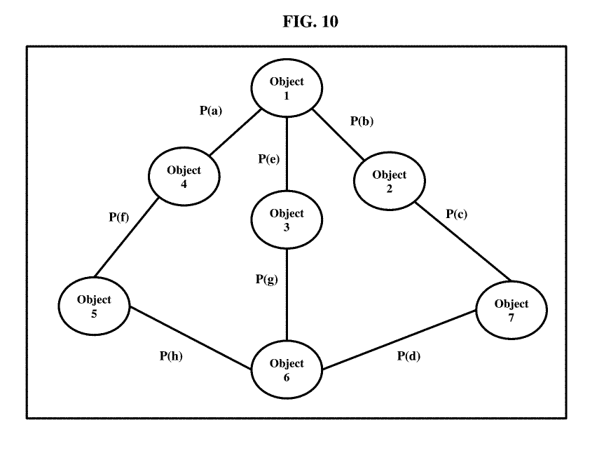

FIG. 10 is the representation of an object repository 150, according to an embodiment as disclosed herein.

Referring to the FIG. 10, the object repository 150 comprises a machine learning manager 152 which is configured to manage the objects graph. The objects graph includes the various objects which are interconnected based on the parameters like current activity of the user, user history, distance between the objects, distance between the current positions of the user to the objects etc. The objects graph indicates a relation between one object to another and the probability of the user to transit from one object to another object.

Below are the example scenarios detailed by considering each of the parameter from the plurality of parameters:

Parameter (1)—Current activity of the user: In an example, consider a scenario in which the current state of the user is moving and the electronic device 1000 is in the first immersive mode (i.e., AR session). The user searches for an object 1 i.e., “Italian Restaurant”. Based on the current search activity of the user, the electronic device 1000 displays the other Italian Restaurants represented by object 2 and object 4 which are within the field-of-view of the electronic device 1000 and object 3, object 5, object 6 and object 7 which could be potential objects of interest which are within the geographic zone. Since object 2 and object 4 are detected as the potential objects of interest, by way of the proposed method, the user may be presented with information about the object 2 and object 4 augmented onto object 2 and object 4 respectively. Further, as object 3 is partially visible to the naked eye of the user (as compared to objects 1, object 2 and object 4 which are completely visible), the electronic device 1000 can be configured to hide/eradicate the non-interested objects which are obstructing the physical view of object 3 from the user. In one scenario, the hiding of the non-interested objects which are obstructing the physical view of object 3 can be done using AR by augmenting the object 3's image from the AR assets database when the user is using the electronic device 1000 pointing towards the object 3. This is done to give a clear view of object 3 to the user when objects of interest are partially visible. In another scenario, the hiding of the non-interested objects can be done by providing an option to the user through the electronic device 1000 to view the object 3 in the VR session (as a VR content of object 3) even though the user is moving and automatic switch to VR has not been initiated. The VR content for e.g. for object 3 would include an outside view of the object 3 and an inside view of object 3 (in case it's a restaurant or café or bank).

Parameter (2)—past activity of the user: In an example, consider a scenario where the motion detection manager 130 of the electronic device 1000 detects the current state of the user is moving and the electronic device 1000 is in the first immersive mode. The user visits “Bank X” represented by object 1 of FIG. 6. The electronic device 1000 intelligently determines based on machine learning, that every time the user visits “Bank X”, the user also visits a nearby restaurant say represented by object 6. Therefore, the electronic device 1000 can be configured to automatically switch to the VR session (i.e., second immersive mode, since object 6 is out of the field-of-view of the electronic device) and indicate information related to the restaurant and prompt the user to visit the restaurant.

Parameter (3)—future activity of the user: In an example, consider a scenario where the motion detection manager 130 of the electronic device 1000 detects the current state of the user is moving and the electronic device 1000 is in the first immersive mode. The user visits “Bank X” say represented by object 1 of FIG. 6. The electronic device 1000 intelligently determines that the user's electricity bill is pending and the electricity board (say represented by object 2) is located within the geographic zone of “Bank X”. Therefore, the electronic device 1000 can be configured to present the electricity bill information to the user along with a nearest location of the electricity board to the user.

Parameter (4)—distance between one object and another object and the distance between a current location of the user and another object. In an example, consider a scenario where the motion detection manager 130 of the electronic device 1000 detects the current state of the user is moving and the electronic device 1000 is in the first immersive mode. The user visits “Bank X” say represented by object 1 of FIG. 6, which is the current location of the user. The electronic device 1000 intelligently determines that the electricity board (say represented by object 2) and the water board (say represented by object 6) are located within the geographic zone of the electronic device 1000. Further, the electronic device 1000 displays the information related to the electricity board and water board with respect to the current location of the user and the distance between the electricity board and the water board. Further, it also suggests to the user which place can be visited first.

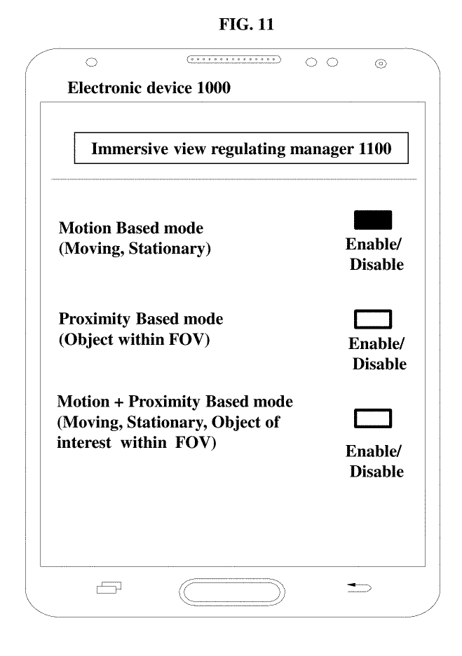

FIG. 11 is an example illustration of a user interface in which Immersive view regulating mode 1100 is described, according to an embodiment herein.

Referring to the FIG. 11, the immersive view regulating manager 1100 includes, for e.g., motion based mode, proximity based mode, and motion plus proximity based mode.

The user can be presented with a graphical element to enable/disable the motion based mode, proximity based mode, and motion and proximity based mode of the immersive view regulating manager 1100.

Once the display manager 190 detects an input, provided by the user, to enable the motion based mode, the immersive view regulating manager 1100 can be configured to communicate with the motion detection manager 130 and regulates the display of information in the first immersive mode and second immersive mode based on the input received from the motion detection manager 130.

Once the display manager 190 detects an input, provided by the user, to enable the proximity based mode, the immersive view regulating manager 1100 can be configured to communicate with the object detection manager 120 and regulates the display of information in the first immersive mode and second immersive mode based on the input received from the object detection manager 120.

Once the display manager 190 detects an input, provided by the user, to enable the option which include the combination of both proximity based mode and motion based mode, the immersive view regulating manager 1100 can be configured to communicate with both the object detection manager 120 and motion detection manager 130 to regulate the display of information in the first immersive mode and second immersive mode based on the input received from both the object detection manager 120 and motion detection manager 130.

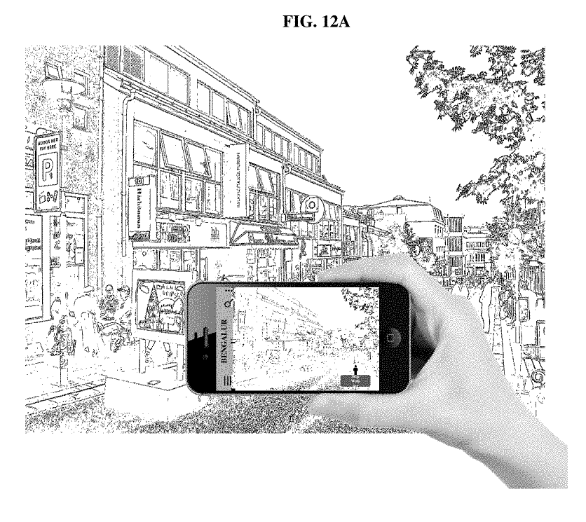

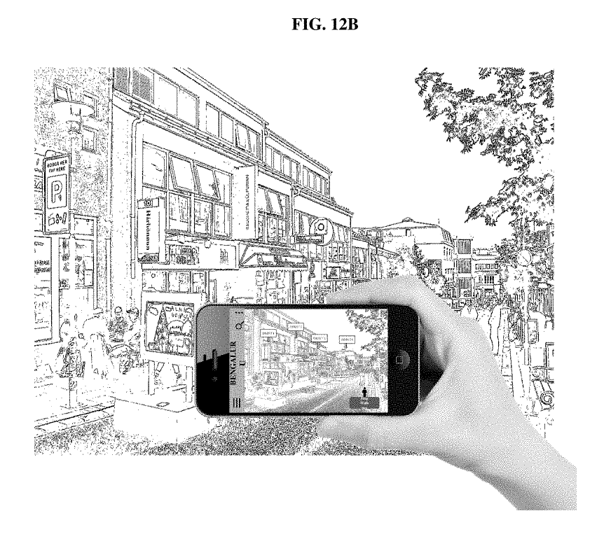

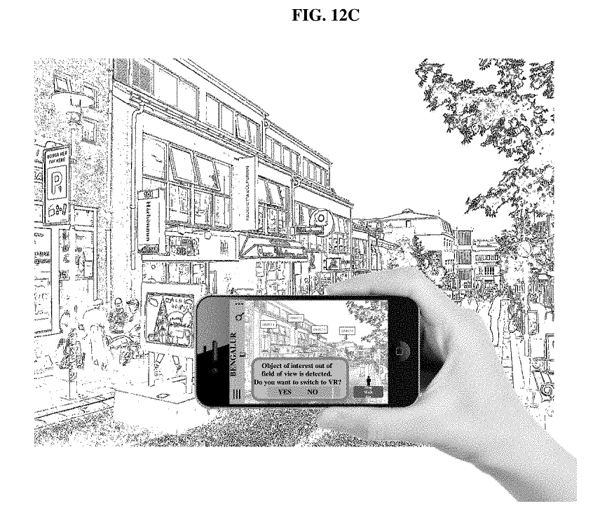

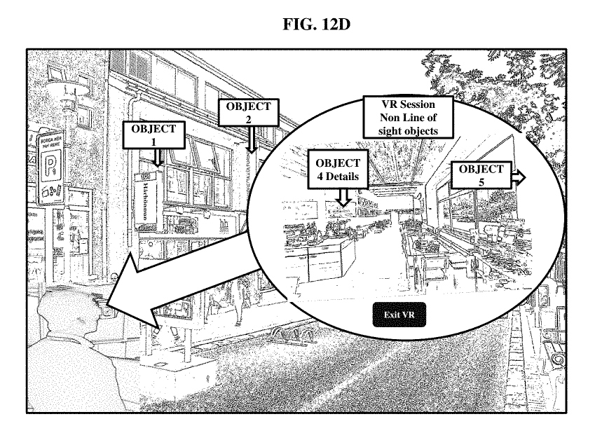

FIG. 12A illustrates the UI of the electronic device 100 displaying the plurality of objects in AR mode while the user is moving, according to an embodiment as disclosed herein.

Referring to the FIG. 12A, in an example, consider that the user is walking in the street with the electronic device 1000. The UI displays the various objects located in the street and which lie within the field of view of the electronic device 1000.

FIG. 12B illustrates the example scenario in which the electronic device 1000 augments information of the plurality of objects in the AR mode while the user is moving, according to an embodiment as disclosed herein.

Referring to the FIG. 12B, the electronic device 1000 displays the plurality of objects which are within its field of view. The object detection manager 120 detects the objects of interest of the user based on the parameters like the current activity of the user, the past activity of the user, the future activity of the user, the relation between one object and another object, the distance between one object and another object, and the distance between the current location of the user and another object etc. Further, the information related to the objects of interest are augmented and presented to the user on the electronic device 1000.

In an example, consider that the user is walking in the street with the electronic device 1000. The object detection manager 120 detects that the object of interest of the user is Chinese restaurant X, based on the current browsing of the user. The object detection manager 120 detects all other Chinese restaurants which are located in the street and within the field of view of the electronic device 1000. Further, the information related to the Chinese restaurants like name of the restaurant, seating availability, home delivery option availability, menu, and customer reviews etc., are augmented on to the Chinese restaurants and presented to the user on the electronic device 1000 in real time.

FIG. 12C illustrates an example scenario in which the electronic device 1000 allows the user to switch to the VR mode on detecting that the object of interest is out of the field of view of the electronic device 1000, according to an embodiment as disclosed herein.

Referring to the FIG. 12C, the object detection manager 120 detects potential objects of interest which are within the vicinity of the electronic device 1000 but are out of the field of view of the electronic device 1000. On determining that the user is stationary, the electronic device 1000 notifies the user that potential objects of interest are detected which are out of the field of view of the electronic device 1000 and allows the user to switch to the VR mode to get the information about these objects of interest.

In conjunction to FIG. 12B, the object detection manager 120 detects Chinese restaurants which are within the vicinity i.e. located in adjacent streets, but are out of the field of view of the electronic device 1000. The electronic device 1000 pops up a message allowing the user to switch to the VR mode to get details about the Chinese restaurants which are out of the field of view of the electronic device 1000 but within the vicinity of the electronic device 1000.

FIG. 12D illustrates the example scenario in which information related to objects of interest which are out of the field of view of the electronic device 1000 are presented in VR mode, according to an embodiment as disclosed herein.

Referring to the FIG. 12D, when the user selects the option to switch to the VR mode, the switching manager 140 switches the display of the contents to VR mode from the AR mode. In the VR mode the electronic device 1000 displays information of the Chinese restaurants which are out of the field of view of the electronic device 1000 but located within the vicinity of the user. The electronic device 1000 allows the user to switch back to VR mode automatically as the user starts moving. The electronic device 1000 also allows the user to switch back to VR mode by manually.

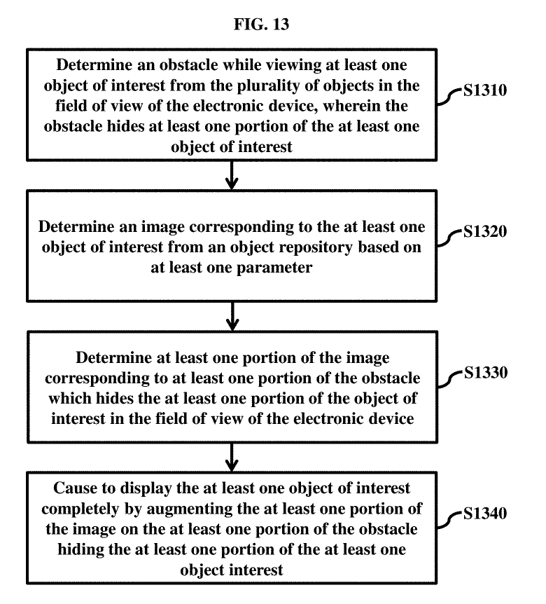

FIG. 13 is a flow diagram illustrating various operations performed by the electronic device to augment at least one portion of an image on at least one portion of an obstacle, according to an embodiment as disclosed herein.

Referring to the FIG. 13, at S1310, the electronic device 1000 determines the obstacle while viewing at least one object of interest from the plurality of objects in the field of view of the electronic device 1000, wherein the obstacle hides at least one portion of the at least one object of interest. For example, in the electronic device 1000 as illustrated in the FIG. 1, the immersive manager 200 can be configured to determine the obstacle while viewing at least one object of interest from the plurality of objects in the field of view of the electronic device 1000, wherein the obstacle hides at least one portion of the at least one object of interest.

Further, at S1320, the electronic device 1000 determines an image corresponding to the at least one object of interest from the object repository 150 based on at least one parameter (e.g., location of the user, user selected object of interest, image recognition of the at least one object of interest, etc.). For example, in the electronic device 1000 as illustrated in the FIG. 1, the immersive manager 200 can be configured to determine the image corresponding to the at least one object of interest from the object repository 150 based on the at least one parameter.

Further, at S1330, the electronic device 1000 determines at least one portion of the image corresponding to the at least one portion of the obstacle which hides the at least one portion of the object of interest in the field of view of the electronic device 1000. For example, in the electronic device 1000 as illustrated in the FIG. 1, the immersive manager 200 can be configured to determine the at least one portion of the image corresponding to the at least one portion of the obstacle which hides the at least one portion of the object of interest in the field of view of the electronic device 1000.

Further, at S1340, the electronic device 1000 causes to display the at least one object of interest completely by augmenting the at least one portion of the image on the at least one portion of the obstacle hiding the at least one portion of the at least one object interest. For example, in the electronic device 1000 as illustrated in the FIG. 1, the immersive manager 200 can be configured to display the at least one object of interest completely by augmenting the at least one portion of the image on the at least one portion of the obstacle hiding the at least one portion of the at least one object interest.

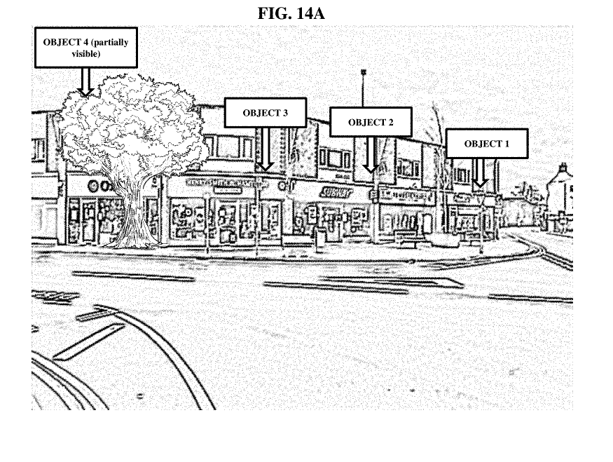

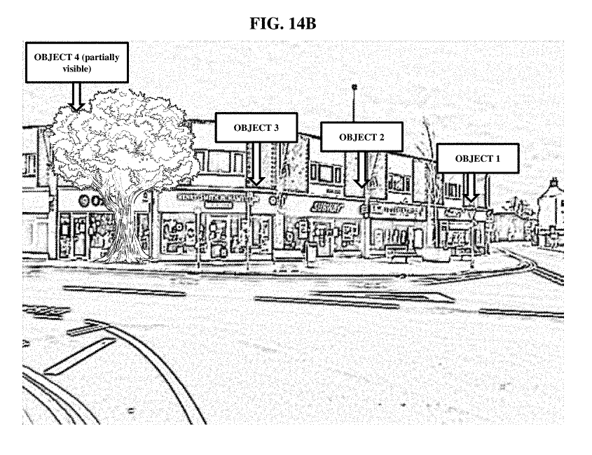

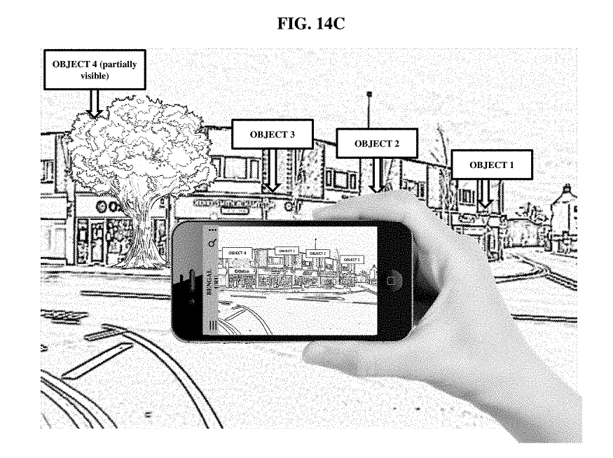

FIGS. 14A-14C illustrates different UIs of the electronic device for augmenting the at least one portion of the image on the at least one portion of the obstacle, according to an embodiment as disclosed herein.

In the conventional methods and systems, if the user wearing the electronic device 1000 and views the object of interest partially (due to an obstacle therebetween) in the AR session, thereby hindering the user experience due to the presence of the obstacle therebetween. As due to the obstacle, the information related to the object of interest cannot be augmented. Thus, the use may not be able to leverage the functionalities of the electronic device 1000 in the AR session for viewing the object of interest. Unlike to conventional methods and systems, the proposed method can be utilized to facilitate the user with the information of the object of interest irrespective of the occurrence of the obstacle between the object of interest and the field of view of the electronic device 1000. The proposed method can be used to remove the obstacle blocking the partially visible object of interest and displays the at least one object of interest completely by augmenting the portion(s) of the image on the portion(s) of the obstacle hiding the portion of the object(s) of interest.

Referring to the FIGS. 14A-14C, for e.g., consider a scenario where object 4 is partially visible (i.e. without AR and physically) to the user due to obstruction from the obstacle (non-interested objects such as for e.g. trees, banners etc.). Since the object 4 is detected as one of the object of interest, the user will be presented with information about object 4 i.e., augmented onto object 4. Further, as the object 4 is partially visible to the naked eye of the user (as compared to objects 1-3 which are completely visible), the electronic device 1000 may intelligently hide the obstacle which are obstructing the physical view of object 4 from the user. In one scenario, the hiding of the non-interested objects which are obstructing the physical view of object 4 can be done using AR by augmenting the object 4's image from the AR assets database 154, when the user is using the electronic device 1000 pointing towards the object 4. This is done to give a clear view of the object 4 to the user when objects of interest are partially visible. In another scenario, the hiding of the non-interested objects can be done by providing an option to the user through the electronic device 1000 to view the object 4 in the VR session (as a VR content of object 4) even though the user is moving and automatic switch to VR has not been initiated. The VR content for e.g. for object 4 would include an outside view of the object 4 and also an inside view of object 4 (in case it's a restaurant or café or bank).

Unlike to conventional methods and systems, the proposed electronic device 1000 can be configured to augment the image (in contrast to augmenting only the information of the object as in conventional systems).

Unlike to conventional methods and systems, the proposed electronic device 1000 can be configured to augment the image on the real world objects which are partially visible to the user. Hence, the user can therefore experience a real time immersive feeling in view of the augmented image on the real world objects.

The embodiments disclosed herein can be implemented through at least one software program running on at least one hardware device and performing network management functions to control the elements. The elements shown in the FIGS. 1 through 14 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for regulating display information in a first immersive mode and a second immersive mode of an electronic device, the method comprising:
displaying, by an immersive manager, a plurality of objects in the first immersive mode in a field of view of the electronic device;
determining, by the immersive manager, an object of interest in vicinity to the electronic device;
detecting, by the immersive manager, a current state of a user of the electronic device; and
regulating, by the immersive manager, display of information of the object of interest in one of the first immersive mode and the second immersive mode based on the current state of the user.

2. The method of claim 1, wherein regulating the display of the information of the object of interest in one of the first immersive mode and the second immersive mode based on the current state of the user comprises:
determining whether the current state of the user is one of a moving state and a stationary state; and
causing the electronic device for one of displaying information about the object of interest in the first immersive mode when the current state of the user is detected as the moving state, and displaying a notification to switch from the first immersive mode to the second immersive mode when the current state of the user is detected as the stationary state.

3. The method of claim 2, wherein the first immersive mode is an Augmented Reality (AR) mode and the second immersive mode is a Virtual Reality (VR) mode.

4. The method of claim 1, wherein regulating the display of the information of the object of interest in one of the first immersive mode and the second immersive mode based on the current state of the user comprises:
determining whether the current state of the user is one of a moving state and a stationary state; and
causing the electronic device for one of displaying information about the object of interest in the first immersive mode when the current state of the user is detected as the stationary state, and displaying a notification to switch from the first immersive mode to the second immersive mode when the current state of the user is detected as the moving state.

5. The method of claim 4, wherein the first immersive mode is VR mode and the second immersive mode is AR mode.

6. The method of claim 1, wherein the plurality of objects, displayed in the field of view of the electronic device, collectively forms a geographic zone which is dynamically identified by a zone recognition manager based on a location of the electronic device.

7. The method of claim 1, wherein determining by the immersive manager the object of interest in vicinity to the electronic device comprising:
determining a probability of a user to transit from a current location to at least one another object in vicinity to the electronic device from an objects repository based on a plurality of parameters; and
selecting the at least one another object as the object of interest from the object repository based on the probability.

8. The method of claim 7, wherein the plurality of parameters comprises a current activity of the user, a past activity of the user, a future activity of the user, a relation between one object and another object, a distance between one object to another object, and a distance between a current location of the user to another object.

9. The method of claim 7, wherein the objects repository comprising an objects graph, formed using a plurality of objects connected among each other based on the plurality of the parameters, wherein the objects graph indicates at least one of a relation between one abject to another and a probability of a user to transit from one object to another object.

10. The method of claim 9, wherein the objects graph is dynamically created by a machine learning manager based on a geographic zone identified by a zone recognition manager of the electronic device.

11. The method of claim 1, wherein the method further comprising, determining, by the immersive manager, an obstacle while viewing at least one object of interest from the plurality of objects in the field of view of the electronic device, wherein the obstacle hides at least one portion of the at least one object of interest;
determining, by the immersive manager, an image corresponding to the at least one object of interest from an object repository based on at least one parameter;
determining, by the immersive manager, at least one portion of the image corresponding to at least one portion of the obstacle which hides the at least one portion of the object of interest in the field of view of the electronic device; and
causing, by the immersive manager, to display the at least one object of interest completely by augmenting the at least one portion of the image on the at least one portion of the obstacle hiding the at least one portion of the at least one object interest.

12. A method for regulating display information in a first immersive mode and a second immersive mode of an electronic device, the method comprising:
displaying, by an immersive manager, a plurality of objects in the first immersive mode;
determining, by the immersive manager, an object of interest in vicinity to the electronic device;
detecting, by the immersive manager, whether the object of interest is available in the field of view of the electronic device; and
regulating, by the immersive manager, display of information of the object of interest in one of the first immersive mode and the second immersive mode based on the availability.

13. The method of claim 12, wherein regulating the display of the information of the object of interest in one of the first immersive mode and the second immersive mode based on the availability comprises:
causing the electronic device for one of displaying information about the object of interest in the first immersive mode when the object of interest is available in the field-of-view of the electronic device, and displaying a notification to switch from the first immersive mode to the second immersive mode when the object of interest is in not available the field-of-view of the electronic device.

14. The method of claim 13, wherein the information about the object of interest is displayed in the first immersive mode when a current state of the user is detected as moving state and the information about the object of interest is displayed in the second immersive mode when a current state of the user is detected as stationary state.

15. The method of claim 13, wherein the first immersive mode is an Augmented Reality (AR) mode and the second immersive mode is a Virtual Reality (VR) mode.

16. The method of claim 12, wherein regulating the display of the information of the object of interest in one of the first immersive mode and the second immersive mode based on the availability comprises:
causing the electronic device for one of displaying information about the object of interest in the first immersive mode when the object of interest is not available in the field-of-view of the electronic device, and displaying a notification to switch from the first immersive mode to the second immersive mode when the object of interest is in available the field-of-view of the electronic device.

17. The method of claim 16, wherein the information about the object of interest is displayed in the first immersive mode when a current state of the user is detected as moving state and the information about the object of interest is displayed in the second immersive mode when a current state of the user is detected as stationary state.

18. The method of claim 16, wherein the first immersive mode is a VR mode and the second immersive mode is an AR mode.

19. The method of claim 12, wherein the plurality of objects, displayed in the field of view of the electronic device, collectively forms a geographic zone which is dynamically identified by a zone recognition manager of the electronic device.

20. The method of claim 12, wherein determining by the immersive manager the object of interest in vicinity to the electronic device comprising:
determining a probability of a user to transit from a current location to at least one another object in vicinity to the electronic device from an object repository based on a plurality of parameters; and
selecting the at least one another object as the object of interest from the object repository based on the probability.

21. The method of claim 20, wherein the plurality of parameters comprises a current activity of the user, a past activity of the user, a future activity of the user, a relation between one object to another object, a distance between one object to another object, and a distance between current location of the user to another object.

22. The method of claim 20, wherein the object repository comprises a machine learning manager configured to manage an objects graph comprising a plurality of objects connected among each other based on the plurality of the parameters, wherein the objects graph indicates at least one of a relation between one abject to another and a probability of a user to transit from one object to another object.

23. The method of claim 22, wherein the objects graph is dynamically created by the machine learning manager based on a geographic zone identified by a zone recognition manager of the electronic device.

24. The method of claim 12, wherein the method further comprising,
determining, by the immersive manager, an obstacle while viewing at least one object of interest from the plurality of objects in the field of view of the electronic device, wherein the obstacle hides at least one portion of the at least one object of interest;
determining, by the immersive manager, an image corresponding to the at least one object of interest from an object repository based on at least one parameter;
determining, by the immersive manager, at least one portion of the image corresponding to at least one portion of the obstacle which hides the at least one portion of the object of interest in the field of view of the electronic device; and
causing, by the immersive manager, to display the at least one object of interest completely by augmenting the at least one portion of the image on the at least one portion of the obstacle hiding the at least one portion of the at least one object interest.

25. A electronic device for managing display information in a first immersive mode and a second immersive mode, the electronic device comprising:
an object repository;
a processor; and
an immersive manager, coupled to the processor and the object repository, configured to:
display a plurality of objects in the first immersive mode in a field of view of the electronic device,
determine an object of interest in vicinity to the electronic device,
detect a current state of a user of the electronic device, and
regulate the display information of the object of interest in one of the first immersive mode and the second immersive mode based on the current state of the user.

26. The electronic device of claim 25, wherein regulating the display information of the object of interest in one of the first immersive mode and the second immersive mode based on the current state of the user comprises:
determining whether the current state of the user is one of a moving state and a stationary state, and
causing one of displaying information about the object of interest in the first immersive mode when the current state of the user is detected as the moving state, and displaying a notification to switch from the first immersive mode to the second immersive mode when the current state of the user is detected as the stationary state.

27. The electronic device of claim 26, wherein the first immersive mode is Augmented reality (AR) mode and the second immersive mode is Virtual reality (VR) mode.

28. The electronic device of claim 25, wherein the immersive manager configured to regulate the display information of the object of interest in one of the first immersive mode and the second immersive mode based on the current state of the user comprises:
determining whether the current state of the user is one of a moving state and a stationary state; and
causing by the immersive manager the electronic device for one of displaying information about the object of interest in the first immersive mode when the current state of the user is detected as the stationary state, and displaying a notification to switch from the first immersive mode to a second immersive mode when the current state of the user is detected as the moving state.

29. The electronic device of claim 28, wherein the first immersive mode is VR mode and the second immersive mode is AR mode.

30. The electronic device of claim 25, wherein the plurality of objects, displayed in the field of view of the electronic device, collectively forms a geographic zone which is dynamically identified by a zone recognition manager based on a location of the electronic device.

31. The electronic device of claim 25, wherein determining by the immersive manager the object of interest in vicinity to the electronic device comprising:
determining a probability of a user to transit from a current position to at least one another object in vicinity to the electronic device from an object repository based on a plurality of parameters; and
selecting the at least one another object as the object of interest from the object repository based on the probability.

32. The electronic device of claim 31, wherein the plurality of parameters comprises a current activity of the user, a past activity of the user, a future activity of the user, a relation between one object and another object, a distance between one object and another object, and a distance between a current location of the user and another object.

33. The electronic device of claim 31, wherein the objects repository comprises an objects graph formed using a plurality of objects connected among each other based on the plurality of the parameters, wherein the objects graph indicates at least one of a relation between one abject to another and a probability of a user to transit from one object to another object.

34. The electronic device of claim 33, wherein the objects graph is dynamically created by a machine learning manager based on a geographic zone identified by a zone recognition manager based on a location of the electronic device.

35. The electronic device of claim 25, wherein the immersive manager is further configured to:
determine an obstacle while viewing at least one object of interest from the plurality of objects in the field of view of the electronic device, wherein the obstacle hides at least one portion of the at least one object of interest;
determine an image corresponding to the at least one object of interest from an object repository based on at least one parameter;
determine at least one portion of the image corresponding to the at least one portion of the obstacle which hides the at least one portion of the object of interest in the field of view of the electronic device; and
cause to display the at least one object of interest completely by augmenting the at least one portion of the image on the at least one portion of the obstacle hiding the at least one portion of the at least one object interest.

36. An electronic device for managing display information in a first immersive mode and a second immersive mode, the electronic device comprising:
an object repository;
a processor; and
an immersive manager, coupled to the processor and the object repository, configured to:
display a plurality of objects in the first immersive mode,
determine an object of interest in vicinity to the user,
detect whether the object of interest is available in the field-of-view of the electronic device, and
regulate the display information of the object of interest in one of the first immersive mode and the second immersive mode based on the availability.

37. The electronic device of claim 36, wherein regulating the display information of the object of interest in one of the first immersive mode and the second immersive mode based on the availability comprises:
causing by the immersive manager the electronic device for one of displaying information about the object of interest in the first immersive mode when the object of interest is available in the field-of-view of the electronic device; and
displaying a notification to switch from the first immersive mode to a second immersive mode when the object of interest is in not available the field-of-view of the electronic device.

38. The electronic device of claim 37, wherein the information about the object of interest is displayed in the first immersive mode when a current state of the user is detected as moving state and the information about the object of interest is displayed in the second immersive mode when a current state of the user is detected as stationary state.

39. The electronic device of claim 37, wherein the first immersive mode is Augmented reality (AR) mode and the second immersive mode is Virtual reality (VR) mode.

40. The electronic device of claim 36, wherein regulating the display information of the object of interest in one of the first immersive mode and the second immersive mode based on the availability comprises:
causing by the immersive manager the electronic device for one of displaying information about the object of interest in the first immersive mode when the object of interest is not available in the field-of-view of the electronic device, and
displaying a notification to switch from the first immersive mode to a second immersive mode when the object of interest is in available the field-of-view of the electronic device.

41. The electronic device of claim 40, wherein the information about the object of interest is displayed in the first immersive mode when a current state of the user is detected as moving state and the information about the object of interest is displayed in the second immersive mode when a current state of the user is detected as stationary state.

42. The electronic device of claim 40, wherein the first immersive mode is VR mode and the second immersive mode is AR mode.

43. The electronic device of claim 36, wherein the plurality of objects, displayed in the field of view of the electronic device, collectively forms a geographic zone which is dynamically identified by a zone recognition manager of the electronic device.

44. The electronic device of claim 36, wherein determining by the immersive manager the object of interest in vicinity to the electronic device comprising:
determining a probability of a user to transit from a current location to at least one another object in vicinity to the electronic device from an object repository based on a plurality of parameters; and
selecting the at least one another object as the object of interest from the object repository based on the probability.

45. The electronic device of claim 44, wherein the plurality of parameters comprises a current activity of the user, a past activity of the user, a future activity of the user, a relation between one object to another object, a distance between one object to another object, and a distance between current position of the user to another object.

46. The electronic device of claim 44, wherein the object repository comprises a machine learning manager configured to manage an objects graph comprising a plurality of objects connected among each other based on the plurality of the parameters, wherein the objects graph indicates at least one of a relation between one object to another and a probability of a user to transit from one object to another object.

47. The electronic device of claim 46, wherein the objects graph is dynamically created by the machine learning manager based on a geographic zone identified by a zone recognition manager of the electronic device.

48. The electronic device of claim 36, wherein the immersive manager is further configured to:
determine an obstacle while viewing at least one object of interest from the plurality of objects in the field of view of the electronic device, wherein the obstacle hides at least one portion of the at least one object of interest;
determine an image corresponding to the at least one object of interest from an object repository based on at least one parameter;
determine at least one portion of the image corresponding to at least one portion of the obstacle which hides the at least one portion of the object of interest in the field of view of the electronic device; and
cause to display the at least one object of interest completely by augmenting the at least one portion of the image on the at least one portion of the obstacle hiding the at least one portion of the at least one object interest.
